(19) United States
(12) Patent Application Publication
(10) Pub. No.: US 2011/0261483 A1
(43) Pub. Date: Oct. 27, 2011

(54) CHANGING THE COMPOSITION AND/OR DENSITY OF GASES INSIDE OF ASSEMBLIES DURING MANUFACTURING

(76) Inventors: Philip Campbell, Bedford, NH (US); Peter Martino, Windham, NH (US); Brian S. Merrow, Harvard, MA (US); Eric L. Truebenbach, Sudbury, MA (US)

(21) Appl. No.: 13/090,744

(22) Filed: Apr. 20, 2011

Related U.S. Application Data
(60) Provisional application No. 61/327,328, filed on Apr. 23, 2010.

(51) Int. Cl. G11B 33/14; F17D 3/00; F17D 1/02

(52) U.S. Cl. 360/97.02; 137/1; 137/4; 137/315.01; G9B/33.035

(57) ABSTRACT

A method of changing a composition and/or a density of gases inside of a hard disk drive. The method includes placing at least one tube into contact with an interior of a hard disk drive, and exchanging gases through the at least one tube. The exchange of gases occurs essentially simultaneously with another hard disk drive manufacturing process step.

### CROSS-REFERENCE TO RELATED APPLICATIONS

This patent application claims the benefit of priority of U.S. Provisional Patent Application No. 61/327,328, filed Apr. 23, 2010. This patent application is also related to PCT patent application Ser. No. ______, filed on even date herewith and entitled “CHANGING THE COMPOSITION AND/OR DENSITY OF GASES INSIDE OF ASSEMBLIES DURING MANUFACTURING” (attorney docket no. 18523-0115WO1). The content of U.S. Provisional Patent Application No. 61/327,328 and of PCT patent application Ser. No. ______ (attorney docket no. 18523-0115WO1) is hereby incorporated by reference into this application as if set forth herein in full.

### TECHNICAL FIELD

This invention relates to changing the composition and/or density of gases inside of assemblies, such as hard disk drives, during manufacturing.

### BACKGROUND

Operation of a hard disk drive can be affected by the composition and density of gas surrounding disk drive media and head assembly of the hard disk drive. Because the head assembly of a hard disk drive flies over the surface of the disk, the composition and density of the gas through which the head assembly flies can affect the flutter, resonance, and other critical parameters of the head assembly in conjunction with the gas. Similarly, the composition and density of the gas surrounding the spinning disk media can affect the turbulence caused by the spinning disk media. Because of the influence of the gas on the disk drive operation, the composition and density of the gas surrounding the disk drive head and media frequently needs to be controlled during disk drive manufacture.

Modern hard disk drives often include a sealed enclosure around the moving parts of the hard disk drive, controlling the composition and density of the gas around these assemblies can include controlling the composition and/or density of the gas inside of the sealed enclosure. Known methods for controlling the composition and/or density of the gas inside the sealed disk drive enclosure include reducing the density of the air within the disk drive enclosure, or introducing a gas, such as helium, into the disk drive enclosure during certain manufacturing process steps. This manipulation of the composition and/or density of the gas present inside of the enclosure has been variously accomplished by placing the entire enclosure inside of a chamber in which the pressure and composition of the gases inside the chamber are controlled, or by exchanging gases through one or more apertures in the enclosure of the hard disk drive. In cases in which the gas or gases are exchanged through apertures in the hard disk drive enclosure, one or more of the apertures are fitted with a valve, either permanently or just for the duration of the manufacture. In other cases a sealing label may be used to temporarily or permanently open and close one or more of the apertures.

Some known methods for exchanging gases inside the hard disk drive enclosure include processing a batch of hard disk drives at the same time in a chamber, or include manual operations to exchange the gas, or include additional process steps to complete, or include the addition of costly components to the hard disk drive

### SUMMARY

In general, this invention relates to changing the composition and/or density of gases inside of assemblies, such as hard disk drives, during manufacturing.

One aspect of the invention features a method of changing the composition and/or density of gases inside of a hard disk drive. The method includes placing at least one tube into contact with the interior of a hard disk drive, and exchanging gases through the at least one tube. The exchange of gases occurs essentially simultaneously with another hard disk drive manufacturing process step.

Another aspect of the invention provides a method of changing the composition and/or density of gases inside of a hard disk drive. The method includes placing at least one tube into contact with the interior of a hard disk drive, and exchanging gases through the at least one tube. The contact between the at least one tube and the interior of the hard disk drive is through at least one self-sealing membrane on the hard disk drive.

Implementations of these methods may include one or more of the following features.

In some implementations, the contact between the at least one tube and the interior of the hard disk drive is through at least one self-sealing membrane on the hard disk drive.

The methods can be performed by automated machinery.

In certain implementations, the at least one self-sealing membrane includes (e.g., is formed of) an elastomer.

In some implementations, the at least one self-sealing membrane comprises a material selected from the group consisting of rubber, butyl, silicone, and fluoroelastomer (e.g., Viton®).

In certain implementations, the contact between the at least one tube and the interior of the hard disk drive is through a one-way valve.

In some implementations, the at least one tube includes at least a first tube and a second tube. In some cases, exchanging gases includes introducing one or more gases into the hard disk drive through the first tube and evacuating one or more gases from the hard disk drive though the second tube. The exchange of gases can be controlled by sensing a composition or density of the gases being evacuated from the hard disk drive, and terminating the exchange of gases when the composition or density meets predetermined criteria.

In certain implementations, the exchange of gases proceeds for a predetermined amount of time.

In some implementations, the exchange of gases proceeds until a predetermined volume of gases has been exchanged.

In certain implementations, exchanging gases includes actuating a gas exchange mechanism.

In another aspect, the invention provides an apparatus for the exchange of gases inside of a hard disk drive. The apparatus includes at least one tube adapted to carry a gas or vacuum, and a mechanism operable to place the at least one tube in contact with the interior of a hard disk drive. The at least one tube and the mechanism are adapted to cause the tube to penetrate a self-sealing membrane on the hard disk drive.

Implementations of the apparatus may include one or more of the following features.

In some implementations, the mechanism to place the at least one tube in contact with the interior of a hard disk drive is adapted to limit the penetration depth of the at least one tube.

In certain implementations, the apparatus also includes a sensor for sensing the composition of the gases flowing through the at least one tube.

In some implementations, the apparatus also includes a sensor for sensing the volumetric flow of the gases flowing through the at least one tube.

In certain implementations, the at least one tube includes a first tube adapted to carry a gas or vacuum, and a second tube adapted to carry a gas or vacuum. The first tube is adapted to inject gases into a hard disk drive, and the second tube is adapted to evacuate gases from the same hard disk drive.

According to another aspect, a hard disk drive includes at least one self-sealing membrane covering at least one aperture between an exterior of the hard disk drive and an interior of the hard disk drive.

Implementations of the hard disk drive may include one or more of the following features.

In some implementations, the at least one aperture and the at least one self-sealing membrane are adapted to allow the exchange of gases between the exterior of the hard disk drive and the interior of the hard disk drive via a tube that is caused to penetrate the self-sealing membrane.

In certain implementations, the at least one self-sealing membrane is of a sufficient thickness to not substantially affect the hard disk drive's fitness for use. In some implementations, the at least one self-sealing membrane includes (e.g., is formed of) an elastomer.

In certain implementations, the at least one self-sealing membrane includes a material selected from rubber, butyl, silicone, and fluoroelastomer (e.g., Viton®).

In some implementations, the self-sealing membrane is adapted to be sufficiently flexible to allow gas pressures inside and outside of the hard disk drive to equalize.

Implementations can include one or more of the following advantages.

Some implementations allow multiple manufacturing process steps to be performed essentially asynchronously, to maintain the continuous nature of the manufacturing process. One advantage of maintaining a continuous flow is that it minimizes the idle time, where a partially completed hard disk drive is waiting for the next process step. Idle time can be an inefficient use of both factory space and inventory cost.

In some implementations, a manufacturing method is provided that can operate continuously, is compatible with automation of the process steps, adds few or no additional process steps, and adds only very low-cost components to the hard disk drive.

In certain implementations, a method is provided for injecting and/or evacuating gases from hard disk drives using automation, implemented in such a way that the method may be executed during some other hard disk drive manufacturing process step.

In some implementations, a method is provided that may be practiced as a separate automated step that is of a small duration compared to many alternatives.

In certain implementations, a methods is provided that may be practiced as part of a manual processing step that is of small duration and of lower likelihood of error compared to many alternatives.

Other aspects, features, and advantages are in the description, drawings, and claims.

### DESCRIPTION OF DRAWINGS

FIG. 1 is a perspective view of a hard disk drive.

FIG. 2 is a perspective view of an end effector assembly.

FIG. 3 is a perspective view of a hard disk drive tester.

FIG. 4 is a perspective view of a hard disk drive with the self-sealing membranes of the current invention applied.

FIG. 5 is a perspective view of an end effector assembly including a pivoting gas exchange mechanism illustrated in a quiescent position.

FIG. 6 is a perspective view of an end effector assembly including a pivoting gas exchange mechanism illustrated in an engaged position.

FIG. 7 is a schematic view of an end effector assembly and associated gas-handling and gas-sensing equipment.

Like reference symbols in the various drawings indicate like elements.

### DETAILED DESCRIPTION

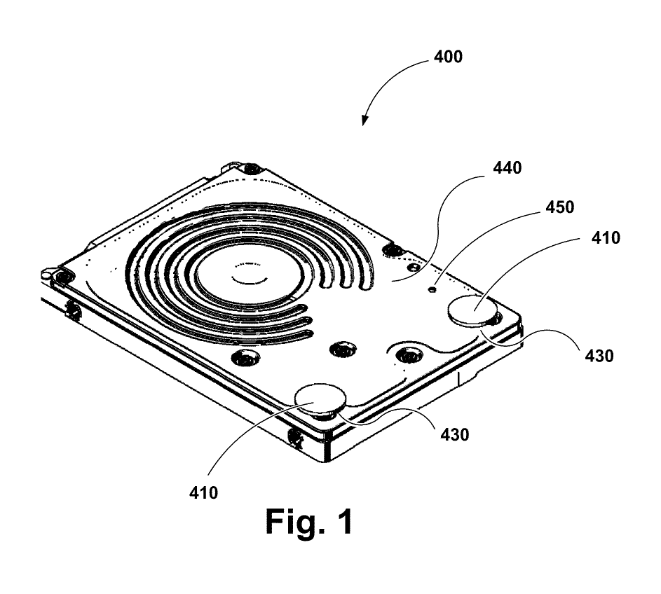

Referring to FIG. 1, a hard disk drive 400 includes a cover 440 that encloses disk media, a head gimbal assembly (HGA), and other parts of the disk drive not shown in FIG. 1. The cover 440 may include one or more apertures 430 that allow gases to exchange between the interior and the exterior of the hard disk drive enclosure. At the end of manufacture, the apertures 430 may be covered by sealing labels 410 to prevent contamination from entering the hard disk drive 400. A hard disk drive 400 may also include a vent 450, which serves to equalize the interior and exterior air pressure during the operating life of the hard disk drive 400. When a vent 450 is present, an internal filter, flexible membrane, or labyrinth connection may be used to prevent contamination from entering the hard disk drive 400.

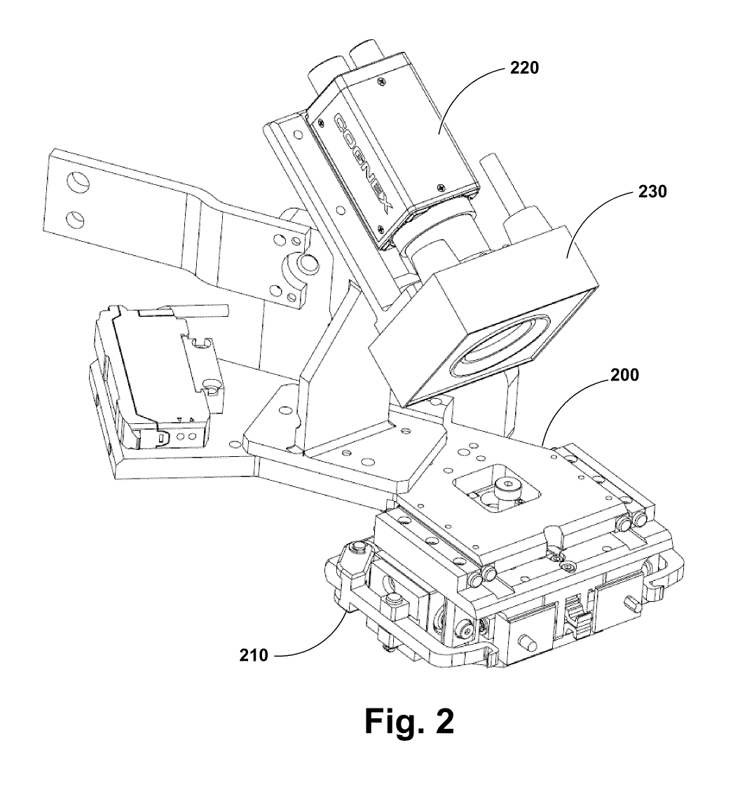

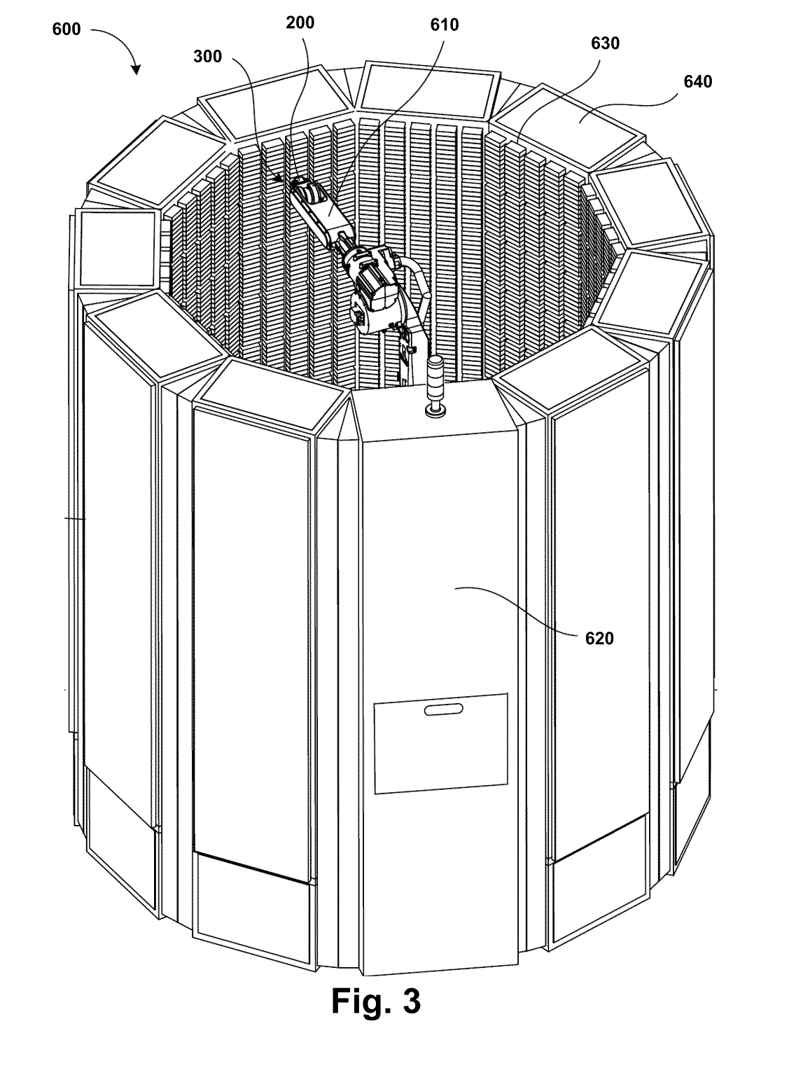

In some hard disk drive manufacturing processes, the hard disk drive 400 may be transported by an automated transporter (see, e.g., item 610, FIG. 3). Referring to FIG. 2, the automated transporter may include an end effector assembly 200, which may include a camera 220, a light source 230, and a mechanical actuator 210. The hard disk drive 400 may be carried by a carrier 300 (FIG. 3) that is gripped by the end effector assembly 200 via the mechanical actuator 210.

Referring to FIG. 3, in some hard disk drive manufacturing processes, the automated transporter 610 attached to the end effector 200 may form part of a larger manufacturing system, for example a hard disk drive test system 600. Such a system may use the automated transporter 610 to transport disk drives from an input/output station 620 to and from test slots 630 housed in racks 640. In the example shown in FIG. 3, the automated transporter 610 carries the disk drive in a carrier 300, gripped by an end effector assembly 200.

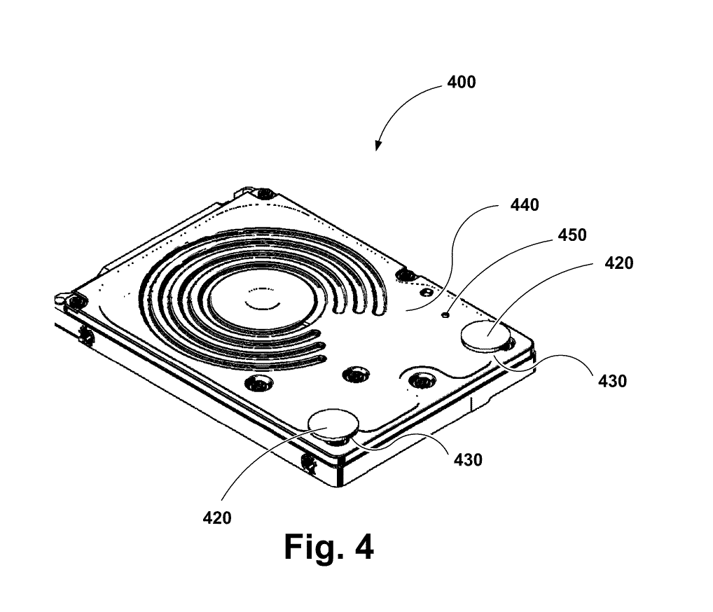

Referring to FIG. 4, in some implementations, the hard disk drive 400 has apertures 430 in its cover 440, extending from the interior space of the hard disk drive 400 to the exterior, each covered by a self-sealing membrane 420. The self-sealing membrane 420 may consist essentially of an elastomer or elastomeric compound. In some implementations, the self-sealing membrane may be of the type that is known in medicine as a septa seal, which is membrane that separates two areas, that can be punctured by a needle, cannula or the like, and which self-seals after the puncturing element is removed. An example is the Longevity™ septa available from SSP Companies. The self-sealing membrane 420 may consist essentially of a suitable elastomer, including but not limited to natural rubber, butyl, silicone, fluoroelastomer (e.g., Viton®); or other self-sealing material. The self-sealing membrane 420 is applied in such a way that, together with the cover 440, it forms an essentially gas-tight seal around the interior of the hard disk drive 400. The self-sealing membrane 420 can be of such a thickness that it may be left in place for the life of the hard disk drive 400 without impeding the fitness of the hard disk drive 400 for use. To achieve this thickness, while also being sufficient to form an essentially gas-tight seal, it may be beneficial for the self-sealing membrane 420 to partially intrude into the interior of the hard disk drive 420. Alternatively, if the self-sealing membrane 420 is not sufficient to form an essentially gas-tight seal of sufficient effectiveness or duration, a sealing label may be applied to cover or replace the self-sealing membrane 420, as part of some final hard disk drive manufacturing process step.

In some implementations, the use of a self-sealing membrane 420 to cover an aperture 430 may obviate the need for a vent 450, as well as any corresponding filter. The flexible nature of the self-sealing membrane 420 may be sufficient to equalize the pressure inside and outside of the hard disk drive 400.

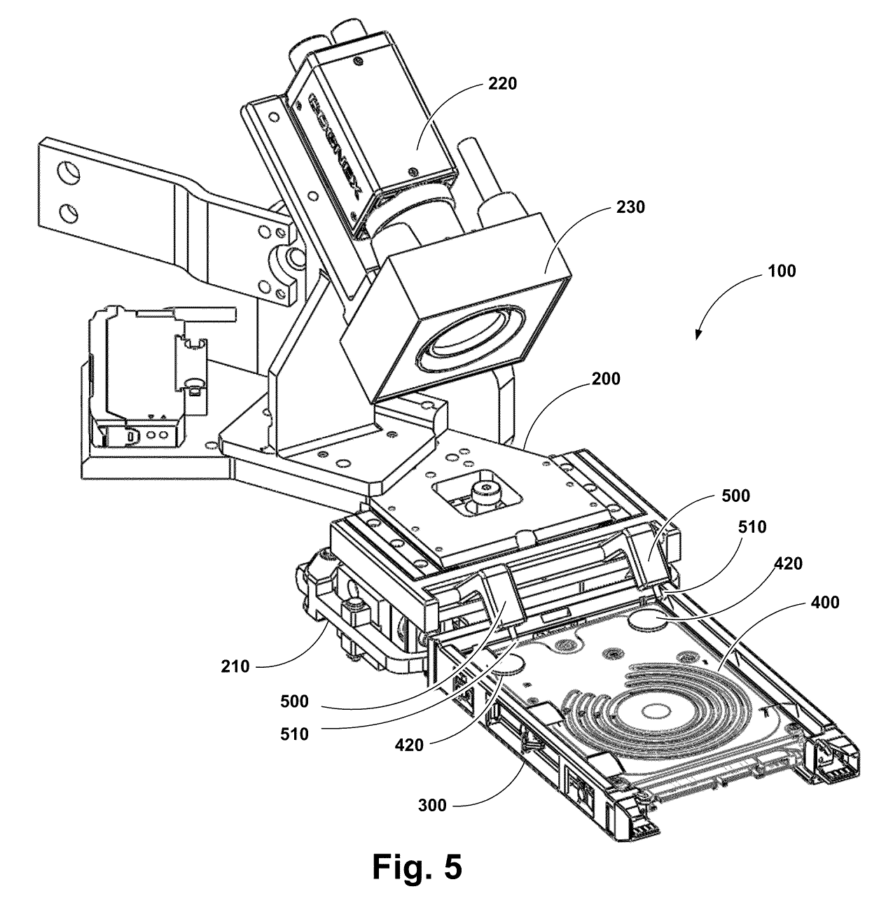

Referring to FIG. 5, in some implementations, an end effector assembly 200 is shown gripping a carrier 300 holding a hard disk drive 400. The end effector assembly 200 is shown also comprising a pivoting gas exchange mechanism which includes two L-shaped assemblies 500, each of which includes a hollow needle 510. The L-shaped assemblies 500 are shown in a position where the hollow needles 510 are held clear of the hard disk drive 400. In this position, whatever density and composition of the gas present inside of the enclosure of disk drive 400 is maintained, and the hard disk drive 400 may be moved into or out of the carrier 300 essentially without hindrance.

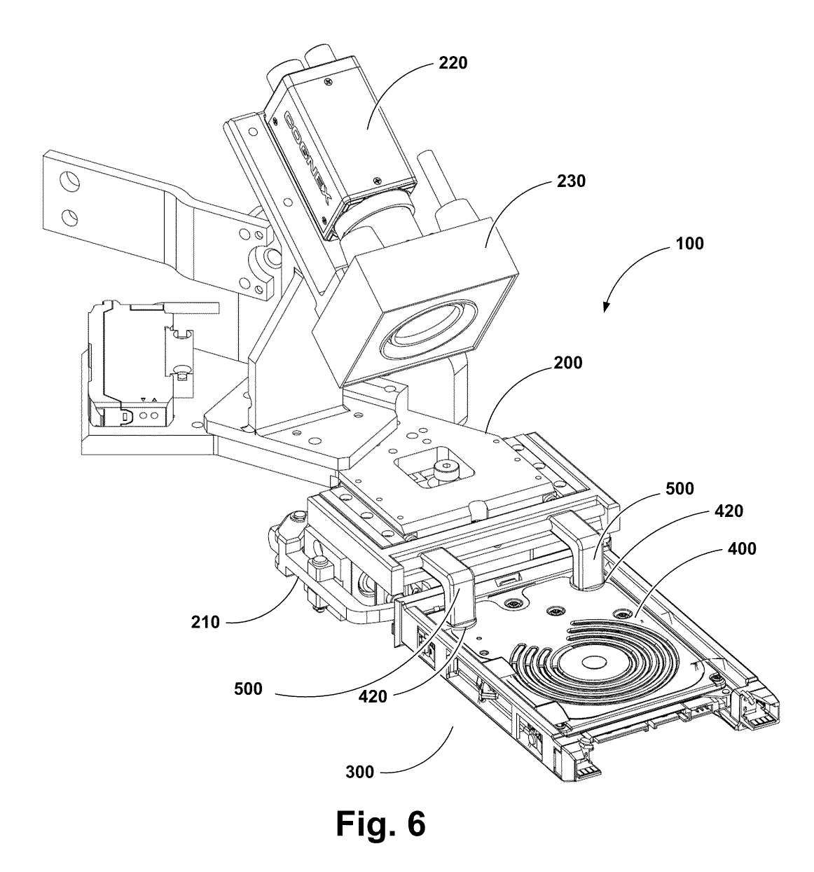

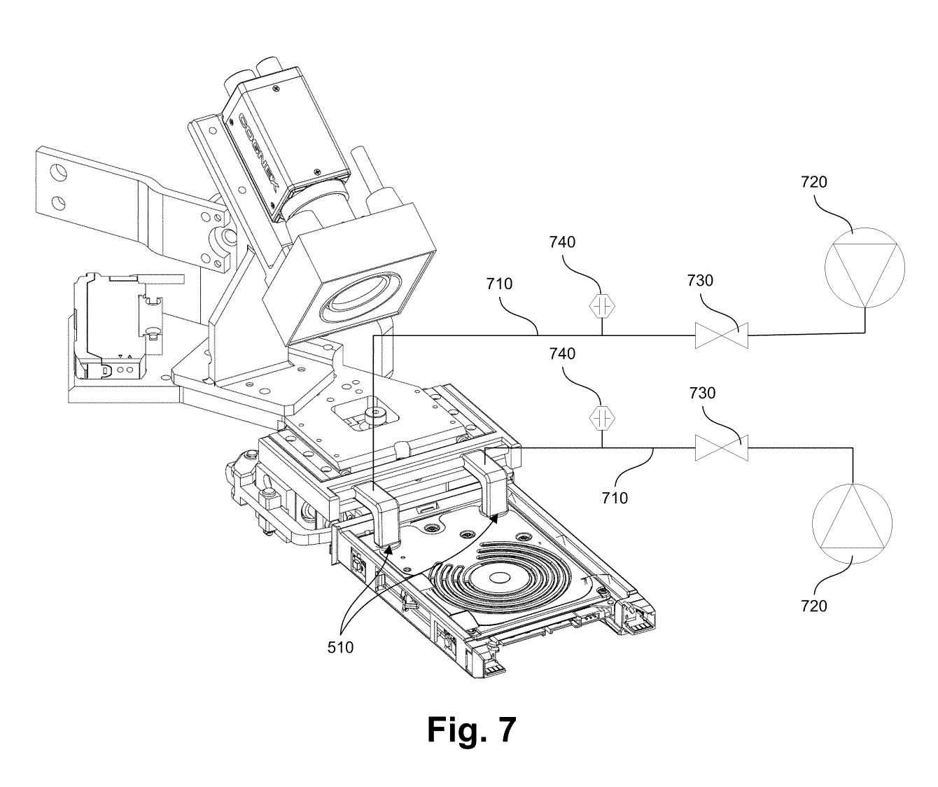

Referring to FIG. 6, in some implementations, an end effector assembly 200 is shown with the two L-shaped assemblies 500 actuated so that the hollow needles 510 penetrate the self-sealing membranes 420. In this position, gas or vacuum may be applied under positive or negative pressure through either one or both of the hollow needles 510, to perform an exchange or evacuation of the gases present inside of the hard disk drive 400. With reference to FIG. 7, the hollow needles 510 are connected by hoses, tubes, conduits, pipes, or other gas-directing means 710 to other gas-handling equipment 720. The connection may incorporate valves 730 or other means for controlling the flow of gas, and gas sensing equipment 740 for sensing the composition, flow, or volume of the gas flowing in to or out of the hard disk drive 400. The gas-handling equipment 720 may be one of, but is not limited to, vacuum pumps, gas tanks, gas generators, and compressors. The gas-sensing equipment 740 may be one of, but not limited to, mass flow controllers, gas spectrometers, and oxygen sensors. The L-shaped assemblies 500 may be actuated by electrical, mechanical, or pneumatic means incorporated in the end effector assembly 200. The L-shaped assemblies 500 may be similarly retracted by opposite electrical, mechanical, or pneumatic means. The hollow needles 510 are preferably of a non-coring type that is adapted for use with self-sealing membranes, and of such a length that the depth of their penetration in to the hard disk drive 400 is limited by the shoulder of the L-shaped assembly 500 to a distance that is sufficient to penetrate the self-sealing membrane 420 but not sufficient to damage any internal component of hard disk drive 400.

In some implementations, a new gas exchange process would be integrated with an existing hard disk drive manufacturing process step in a hard disk drive test system 600 as follows:
1. A hard disk drive 400 is introduced into the hard disk drive test system 600 via the input/output station 620.
2. The automated transporter 610 retrieves the hard disk drive 400 from the input/output station 620 by first retrieving a carrier 300 from an empty test slot 630, and then transferring the disk drive 400 from the input/output station 620 to the carrier 300. The L-shaped assemblies 500 are retracted throughout this step, so the hard disk drive 400 may be transferred to the carrier 300 without hindrance.
3. Immediately after the hard disk drive 400 is removed from the input/output station 620, the L-shaped assemblies 500 are activated. This actuation causes the L-shaped assemblies 500 to pivot towards the top of the hard disk drive 400, so that the hollow needles 510 penetrate the self-sealing membranes 420.
4. As the hard disk drive 400 is transported from the input/output station 620 to the test slot 630, the gas-handling equipment is activated to cause a gas exchange or evacuation, with the aim of changing the composition, the density, or both, of the gas inside of the hard disk drive 400. In some implementations, the gas exchange or evacuation may be limited by time and flow. In other implementations, the gas or vacuum exchange may be limited by volume. In yet other implementations, the gas exchange or evacuation may be limited by sensing the composition of the gas flowing out of the hard disk drive 400, and maintaining the gas flow until such time as the composition and density of the gas meets predetermined criteria.
5. Before the hard disk drive is inserted into the test slot 630, the L-shaped assemblies 500 are refracted. This retraction causes the L-shaped assemblies 500 to pivot away from the hard disk drive 400, thus causing the self-sealing membranes 420 to seal, and the hard disk drove 400 to be available for insertion in the test slot 630 without hindrance.

In some implementations, a similar set of actions causes the gas in the hard disk drive 400 to be exchanged or evacuated while being transported from the test slot 630 to the input/output station 620.

In some implementations, the self-sealing membranes 420 may be covered or replaced by an adhesive sealing label as part of a later process step.

In some implementations, the vent 450 may be covered as part of an earlier manufacturing process step. In some implementations, the vent 450 may be uncovered as part of a later manufacturing process step.

A number of implementations of the invention have been described. Nevertheless, it will be understood that various modifications may be made without departing from the spirit and scope of the invention.

For example, in some implementations, the gas may be exchanged by injecting pressurized gas through a first of the two apertures 430, and evacuating the previous gas through a second of the two apertures 430.

In some implementations, a single aperture 430 may be present, and the gas is exchanged by first evacuating essentially all of the gas through the single aperture 430, and subsequently gas is injected through the same aperture 430.

In some implementations, more than two apertures 430 and self-sealing membranes 420 may be present.

In some implementations, the process or apparatus may be used to alter the density of the gas inside of the hard disk drive enclosure, up to and including creating a vacuum.

In some implementations, one or both of the hollow needles 510 may be replaced by a cannula, pipe, or other gas-carrying tube.

In some implementations, the L-shaped assemblies 500 may have other shapes that are sufficient to carry the hollow needles 510.

In some implementations, the action by which the hollow needle 510 or its equivalent is caused to penetrate the self-sealing membrane 420 is not pivotal, but linear, or rotary, or some other motion sufficient to translate the tip of hollow needle 510 a sufficient distance through the self-sealing membrane 420 into the hard disk drive 400.

In some implementations, one or more of the self-sealing membranes 420 is replaced by a mechanical valve, such as a ball valve, a flapper valve, a reed valve, or any other such valve that will remain closed as long as the gas pressure inside of the hard disk drive 400 exceeds that of the surrounding environment. In such cases, any process for the exchange of gases inside of the hard disk drive 400 must end in such a state that the internal pressure of the hard disk drive 400 exceeds that of the surrounding environment, if it is required that the valve remain closed.

In some implementations, one or more of the self-sealing membranes 420 is replaced by a mechanical valve, such as a ball valve, a flapper valve, a reed valve, or any other such valve that will remain closed as long as the gas pressure inside of the hard disk drive 400 is less than that of the surrounding environment. In such cases, any process for the exchange or evacuation of gases inside of the hard disk drive 400 must end in such a state that the internal pressure of the hard disk drive 400 is less than that of the surrounding environment, if it is required that the valve remain closed.

In some implementations, the action that causes the hollow needles 510 to penetrate the self-sealing membrane 420 is that of moving the hard disk drive 400, rather than that of moving the L-shaped assemblies 500.

In some implementations, the hard disk drive 400 is gripped directly by a mechanical actuator, or is held statically in a fixture, or is made available to the gas exchange or evacuation mechanism by some means other than by being held in a carrier 300.

In some implementations, the position of the apertures 430 and the self-sealing membranes 420 may be elsewhere on the hard disk drive 400 besides on the cover 440.

In some implementations, the gas exchange or evacuation process is executed during some hard disk drive manufacturing process step other than transport inside of a hard disk drive tester 600, including but not limited to:

transport or some other handling operation inside of some other type of hard disk drive manufacturing equipment;

transport of the hard disk drive 400 around a manufacturing facility;

loading or unloading the hard disk drive 400 to or from a conveyor;

during test of the hard disk drive 400, for example inside of the test slot 630; and

inside of a clean room during some manufacturing process there.

In some implementations, the gas exchange or evacuation process is executed as a separate manufacturing process step, not combined with some other manufacturing process step. In such implementations, the simplicity, speed, and reduced incidences of errors characteristic of the current invention are still an improvement over existing processes.

In some implementations, the gas exchange or evacuation process is executed essentially manually, with a manual execution of any or all of:

the actuation of the L-shaped assemblies 500;

the gas exchange or evacuation; and

the disengagement of the L-shaped assemblies 500.

In such manual implementations of the gas exchange or evacuation process, the simplicity, speed, and reduced incidences of errors characteristic of the current invention are still an improvement over existing processes.

Accordingly, other implementations are within the scope of the following claims.

What is claimed is:

1. A method of changing a composition and/or a density of gases inside of a hard disk drive, the method comprising:
placing at least one tube into contact with an interior of a hard disk drive; and
exchanging gases through the at least one tube;
wherein the exchange of gases occurs essentially simultaneously with another hard disk drive manufacturing process step.

2. The method of claim 1, wherein the contact between the at least one tube and the interior of the hard disk drive is through at least one self-sealing membrane on the hard disk drive.

3. The method of claim 2, wherein the method is performed by automated machinery.

4. The method of claim 2, wherein the at least one self-sealing membrane comprises an elastomer.

5. The method of claim 4, wherein the at least one self-sealing membrane comprises a material selected from the group consisting of rubber, butyl, silicone, and fluoroelastomer.

6. The method of claim 1, wherein the contact between the at least one tube and the interior of the hard disk drive is through a one-way valve.

7. The method of claim 1, wherein the method is performed by automated machinery.

8. The method of claim 1, wherein the at least one tube comprises at least a first tube and a second tube.

9. The method of claim 8, wherein exchanging gases comprises:
introducing one or more gases into the hard disk drive through the first tube; and
evacuating one or more gases from the hard disk drive though the second tube.

10. The method of claim 9, wherein the exchange of gases is controlled:
sensing a composition or density of the gases being evacuated from the hard disk drive; and
terminating the exchange of gases when the composition or density meets predetermined criteria.

11. The method of claim 1, wherein the exchange of gases proceeds for a predetermined amount of time.

12. The method of claim 1, wherein the exchange of gases proceeds until a predetermined volume of gases has been exchanged.

13. The method of claim 1, wherein exchanging gases comprises actuating a gas exchange mechanism.

14. A method of changing a composition and/or density of gases inside of a hard disk drive, the method comprising:
placing at least one tube into contact with an interior of a hard disk drive; and
exchanging gases through the at least one tube;
wherein the contact between the at least one tube and the interior of the hard disk drive is through at least one self-sealing membrane on the hard disk drive.

15. The method of claim 14, wherein the method is performed by automated machinery.

16. The method of claim 14, wherein the at least one self-sealing membrane comprises an elastomer.

17. The method of claim 14, where the at least one self-sealing membrane comprises a material selected from the group consisting of rubber, butyl, silicone, and fluoroelastomer.

18. The method of claim 14, wherein the at least one tube comprises at least a first tube and a second tube.

19. The method of claim 18, wherein exchanging gases comprises:
introducing one or more gases into the hard disk drive through the first tube; and
evacuating one or more gases from the hard disk drive though the second tube.

20. The method of claim 19, wherein the exchange of gases is controlled by:
sensing a composition or a density of the gases being evacuated from the hard disk drive; and
terminating the exchange of gases when the composition or the density meets predetermined criteria.

21. The method of claim 14, where the exchange of gases proceeds for a predetermined amount of time.

22. The method of claim 14, where the exchange of gases proceeds until a predetermined volume of gases has been exchanged.

23. The method of claim 14, further comprising actuating a gas exchange mechanism to exchange the gases through the at least one tube.

24. An apparatus for the exchange of gases inside of a hard disk drive, comprising:
at least one tube adapted to carry a gas or a vacuum; and
a mechanism operable to place the at least one tube in contact with an interior of a hard disk drive;
wherein the at least one tube and the mechanism are adapted to cause the tube to penetrate a self-sealing membrane on the hard disk drive.

25. The apparatus of claim 24, wherein the mechanism to place the at least one tube in contact with the interior of a hard disk drive is adapted to limit a penetration depth of the at least one tube.

26. The apparatus of claim 24, further comprising a sensor for sensing a composition of the gases flowing through the at least one tube.

27. The apparatus of claim 24, further comprising a sensor for sensing a volumetric flow of the gases flowing through the at least one tube.

28. The apparatus of claim 24, wherein the at least one tube comprises:
a first tube adapted to carry a gas or a vacuum; and
a second tube adapted to carry a gas or a vacuum,
wherein the first tube is adapted to inject gases into a hard disk drive, and the second tube is adapted to evacuate gases from the same hard disk drive.

29. A hard disk drive comprising at least one self-sealing membrane covering at least one aperture between an exterior of the hard disk drive and an interior of the hard disk drive.

30. The hard disk drive of claim 29, wherein the at least one aperture and the at least one self-sealing membrane are adapted to allow the exchange of gases between the exterior of the hard disk drive and the interior of the hard disk drive via a tube that is caused to penetrate the self-sealing membrane.

31. The hard disk drive of claim 30, wherein the at least one self-sealing membrane is of a sufficient thickness to not substantially affect the hard disk drive's fitness for use.

32. The hard disk drive of claim 29, wherein the at least one self-sealing membrane comprises an elastomer.

33. The hard disk drive of claim 29, wherein the at least one self-sealing membrane comprises a material selected from the group consisting of rubber, butyl, silicone, and fluoroelastomer.

34. The hard disk drive of claim 29, wherein the self-sealing membrane is adapted to be sufficiently flexible to allow gas pressures inside and outside of the hard disk drive to equalize.
